(19) United States
(12) Patent Application Publication
(10) Pub. No.: US 2023/0038080 A1
(43) Pub. Date: Feb. 9, 2023

(54) METHOD FOR PRINTING ON A WORKPIECE AND PRINTING DEVICE

(71) Applicant: Homag GmbH, Schopfloch (DE)

(72) Inventors: Ludwig ALBRECHT, Dornstetten-Aach (DE); Achim HOMEIER, Pfalzgrafenweiler (DE)

(73) Assignee: Homag GmbH, Schopfloch (DE)

(21) Appl. No.: 17/759,138

(22) PCT Filed: Jan. 18, 2021
(86) PCT No.: PCT/EP2021/050913

§ 371 Date: Jul. 20, 2022

(30) Foreign Application Priority Data
Jan. 21, 2020 (DE) 10 2020 101 308.6

(51) Int. Cl. B41J 11/00; B41J 3/407; B41M 5/00

(52) U.S. Cl. CPC B41J 11/0095; B41J 11/007; B41J 3/4073; B41M 5/0076; B41M 5/0064; B41J 2203/01

(57) ABSTRACT

A method is for printing on a narrow face of a workpiece, in which surface information relating to at least some regions of at least one workpiece face adjoining the narrow face to be printed on is optically captured by a sensor device, the captured surface information is transferred to a print controller, and the print controller ascertains print information for controlling a printing unit on the basis of the captured surface information. The print information is used to control a printing process by which a narrow face decoration, which is matched to a decoration flow of the optically captured workpiece face, is printed on the narrow face.

### TECHNICAL FIELD

The invention relates to a method for printing on a surface of a workpiece and to a printing device for printing on a surface of a workpiece.

### PRIOR ART

To produce furniture parts or other structural components, workpieces made of a wood material, for example particle boards or fiberboards, are often used. For visual and functional reasons, such workpieces are usually provided with a coating material, which is provided on both the wide faces of the workpiece and the narrow faces. The coating material on the wide face can have a decoration, for example in the form of a reproduced woodgrain, a stone reproduction or the like, which can be reproduced on the narrow faces by means of a subsequent printing process with a printing device. To this end, the decoration on the wide face can be captured by means of an imaging process to enable it to be printed onto the narrow face. However, capturing the wide face generates large volumes of data, which have to be processed by a controller, and this results in extended processing times, especially when printing on a plurality of workpieces. Moreover, visual deviations in decoration flows between adjoining workpiece faces can occur with this printing process, so that a grain flow on the wide face does not match up with the grain flow on the narrow face, for example.

### SUMMARY OF THE INVENTION

The invention is based on the problem of proposing a method for printing on a surface of a workpiece with which a high-quality visual impression of the workpiece can be formed. The invention also addresses the problem of proposing a printing device with which a high-quality print on a workpiece can be obtained.

A method for printing on at least one narrow face of a workpiece is defined in claim 1. A printing device for printing on at least one narrow face of a workpiece is defined in claim 9. Dependent claims relate to specific embodiments.

The method for printing on at least one narrow face of a workpiece, in particular a workpiece made at least partly of wood, a wood material, synthetic material, composite material or the like and provided at least in some regions with a coating material, comprises the steps whereby surface information relating to at least some regions of at least one workpiece face adjoining the narrow face to be printed on is optically captured by a sensor device, the captured surface information is transferred to a print controller, and the print controller ascertains print information for controlling a printing unit on the basis of the captured surface information, wherein the print information is used to control a printing process by means of which a narrow face decoration, which is matched to a decoration flow of the optically captured workpiece face, is printed on the at least one narrow face.

By matching the decoration flow between the workpiece face and the narrow face, a high-quality visual impression of the workpiece can be achieved. In particular, the surfaces of the workpiece are provided with a coating material. This coating material can be, for example, a wood veneer, a surface paper, a coating lacquer or similar. The coating material provided on the wide faces of the workpiece can have a decoration, for example in the form of a reproduced woodgrain, a stone reproduction, a graphical pattern or an image, wherein a matching narrow face decoration can be printed on the at least one narrow face by means of the printing process. The decorations of adjoining workpiece faces can be matched to one another in this way to avoid any visual disruption of the decoration flow at the transition from one workpiece face to an adjacent workpiece face—for example, a grain flow on the wide face matches up with the grain flow on the narrow face. In addition, if the surface information is captured on only some regions of the workpiece face, then only a small volume of data is generated, enabling the print controller to process the data quickly in order to control the printing process. The processing times can be reduced in this way, so that the workpieces can be printed on in a continuous process.

An advantageous further development of the method can provide that the print controller uses the captured surface information to ascertain a corresponding decoration template from a decoration data set, and the print information for controlling the printing process is ascertained or derived from the decoration template.

In this way, the decoration template serving as a print template can be identified from the data set using the captured surface information. By ascertaining or deriving the print information from this decoration template, a narrow face decoration can be reproduced on the narrow face, the decoration flow of which is matched to the decoration flow of the workpiece face.

A further advantageous embodiment of the method can provide that the optically captured workpiece face comprises a workpiece decoration which corresponds to a decoration detail from the ascertained decoration template, wherein the print controller uses the captured surface information and/or the workpiece dimensions to determine the exact position of the corresponding decoration detail from the decoration template, and the print information for printing the narrow face decoration is ascertained from at least one decoration region of the decoration template.

By determining the exact position of the decoration detail in the decoration template, the decoration flow of the narrow face decoration can be matched particularly precisely to the decoration flow of the workpiece decoration.

In a particularly preferred further development of the method, the print information for printing the narrow face decoration can be ascertained from a decoration region of the decoration template that adjoins the decoration detail of the workpiece decoration in the decoration template, wherein this decoration region is printed onto the narrow face in such a way that a matching decoration flow is achieved between the workpiece decoration of the workpiece face and the narrow face decoration of the narrow face.

In this way, a decoration strip that adjoins the decoration detail of the workpiece face is ascertained from the decoration template. The decoration strip has a width that corresponds to the thickness of the workpiece. The print information is ascertained from this decoration strip, and an image of the decoration strip is printed in a positionally accurate manner onto the narrow face of the workpiece.

An advantageous embodiment of the method can provide that the printing unit is positioned relative to the narrow face by means of a positioning device, wherein the printing unit is arranged in a defined position relative to the narrow face, based on the captured surface information, and the printing process is controlled so as to match the decoration flow of the workpiece decoration of the workpiece face.

Using the positioning device, an exact positioning of the printing unit relative to the workpiece can be ascertained, provided and monitored. This can take place in particular before the start of the printing process, so that the position of the printing unit can be precisely aligned and adjusted. In particular if the printing unit and the workpiece are moved relative to one another during the printing process, a monitoring of the positioning of the printing unit can also be facilitated.

A further preferred embodiment of the method can provide that a continuous or discontinuous conveying movement of the workpiece or a continuous or discontinuous traversing movement of the printing unit is performed during the capture of the surface information and/or during the execution of the printing process.

This enables workpieces to be printed on in a continuous process, so that a plurality of workpieces can be printed on one after another. In this case, the workpieces can execute the conveying movement during the printing process. Equally, it can be provided that the conveying movement is interrupted in order to carry out the printing process.

In an alternative further development of the method, the surface information relating to a peripheral region of the workpiece face that adjoins the narrow face to be printed on can be optically captured, and the print information for printing the narrow face decoration can be ascertained or derived from the captured surface information relating to the peripheral region.

It can be provided in particular here that the narrow face decoration is printed onto the narrow face by means of the printing process in such a way that a matching decoration flow between the workpiece face and the narrow face is achieved. It can be provided in particular that the peripheral region of the workpiece face is captured by a traversing movement of the sensor device and the print information is ascertained or derived and the printing process on the at least one narrow face is carried out substantially at the same time.

Moreover, an advantageous embodiment of the method can provide that the capture of the surface information and the execution of the printing process to print the narrow face decoration are carried out in real time, preferably in direct succession. The capture of the surface information and the execution of the printing process can thus be carried out substantially at the same time. Very short processing times for printing on the at least one narrow face of the workpiece can be achieved in this way.

The printing device for printing on at least one narrow face of a workpiece, in particular a workpiece made at least partly of wood, a wood material, synthetic material, composite material or the like and provided at least in some regions with a coating material, comprises at least one printing unit for printing on the at least one narrow face of the workpiece, wherein the printing unit and/or the workpiece are intended to be movable relative to one another in order to carry out the printing process, wherein a sensor device is provided, by means of which surface information relating to at least some regions of at least one workpiece face adjoining the narrow face to be printed on can be optically captured, and a print controller, by means of which a method in accordance with one of the embodiments described above can be carried out in order to control the at least one printing unit.

With such a printing device, at least one narrow face of the workpiece can be printed on with a narrow face decoration which is matched to a decoration flow of the adjoining workpiece face. In this way, the workpiece can be provided with a decoration that conveys a high-quality visual impression, for example in the form of a reproduced woodgrain, a stone reproduction, or another graphical pattern or image. In particular, the surfaces of the workpiece are provided with a coating material, for example a wood veneer, surface paper and/or coating lacquer or the like. By capturing the surface information on at least some regions of the workpiece face, the volume of data can be reduced, enabling the print controller to process the data more quickly. Much faster processing times can be achieved in this way, so that the narrow faces of the workpieces can be printed on by means of this printing device in a continuous process, with a narrow face decoration matched to the workpiece decoration of the wide face.

An advantageous further development of the printing device can provide that a conveyor system for accommodating a plurality of workpieces is provided, by means of which the workpieces can be conveyed in a continuous or discontinuous conveying movement, wherein the narrow faces can be printed on by the printing unit during the continuous or discontinuous conveying movement. Such a conveyor system can enable workpieces to be printed on in a continuous process.

The workpieces can execute the conveying movement during the printing process, or the conveying movement can be interrupted for the printing process. The processing times can be considerably reduced in this way, allowing a plurality of workpieces to be printed on one after another. The capture of the surface information and the execution of the printing process can take place in real time, i.e. substantially at the same time, so that the processing times can be further reduced.

### BRIEF DESCRIPTION OF THE DRAWINGS

Further features and advantages of an apparatus, a use and/or a method can be found in the following description of embodiments, with reference to the appended drawings, as follows:

FIG. 1 shows a schematic view of a printing device for printing on a narrow face of a workpiece;

FIG. 2 shows a schematic view of a decoration template and of a workpiece with a workpiece decoration;

FIG. 3 shows a flow chart of a printing method for printing on narrow faces of a workpiece.

### DESCRIPTION OF EMBODIMENTS

Equal reference numbers that appear in different drawings denote identical, corresponding or functionally similar elements.

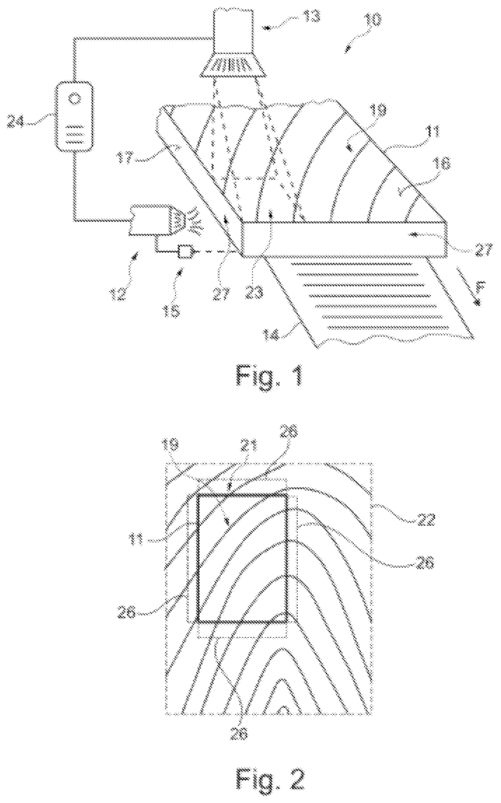

FIG. 1 shows a schematic view of a printing device 10 for printing on a workpiece 11. The printing device 10 comprises a printing unit 12 for carrying out a printing process and a sensor device 13, by means of which surface information 14 relating to the workpiece 11 can be optically captured.

The printing device 10 is designed in particular as a continuous device in which for the printing process the workpieces 11 are conveyed in a passage direction relative to the printing unit 12. The printing device 10 comprises a transport system 14, by means of which the workpieces 12 are conveyed to the printing unit 12 one after another, i.e. in a continuous process. The workpieces 12 can be conveyed with a continuous or discontinuous conveying movement F. The printing unit 12 can be designed to be multiaxially movable in order to position it relative to the workpiece 12 to be printed on. For example, the printing unit 12 can also be arranged relative to a plurality of side regions of the workpiece 11. Equally, a plurality of printing units 12 can be provided, each of which is assigned to a side region of the workpiece 11. The printing unit 12 comprises a positioning device 15, by means of which a position of the printing unit 12 relative to the workpiece 11 can be determined and monitored. The position can be determined by laser capture, for example. Alternatively, the printing device 10 can equally be designed as a static printing device 10, in which the workpieces 11 are accommodated in a fixed manner and the printing unit 12 is moved relative to the workpiece 11 in order to carry out the printing process.

The workpieces 11 to be printed on are preferably workpieces 11 made at least partly of wood, wood materials, synthetic material, a composite material or the like. The workpieces 11 are preferably in the form of boards, for example solid wood board, particle board, fiberboard or the like. These can be intended for the manufacture of both furniture and structural components.

A coating material is provided on the workpiece faces of the workpiece 11. The coating material is provided both on the wide faces 16 and on the narrow faces 17 of the workpiece 11. The coating material provided on the wide faces 16 comprises a workpiece decoration 19. This workpiece decoration 19 is designed as, by way of example, a reproduced woodgrain, as shown in FIGS. 1 and 2. In an alternative embodiment, the workpiece decoration 19 can equally be a stone reproduction, a graphical pattern or an image. The coating material on the wide face 16 can be provided with the workpiece decoration 19 either before being applied to the workpiece 11 or after being applied to the workpiece 11. For example, the workpiece decoration 19 can be printed onto the coating material.

The workpiece decoration 19 is a decoration detail 21 from a decoration template 22. FIG. 2 shows such a decoration template 22 using woodgrain as an example. This decoration detail 21 corresponds to the dimensions of the wide face 16 and is provided on the wide face 16 of the workpiece 11 in the form of a veneer or coating material in order to form the workpiece decoration 19. On the narrow faces 17 of the workpiece 11, there is likewise provided a coating material, for example a surface paper or a coating lacquer, which is printed on with a narrow face decoration 27 matched to the workpiece decoration 19 by means of a printing process with the printing device 10, however.

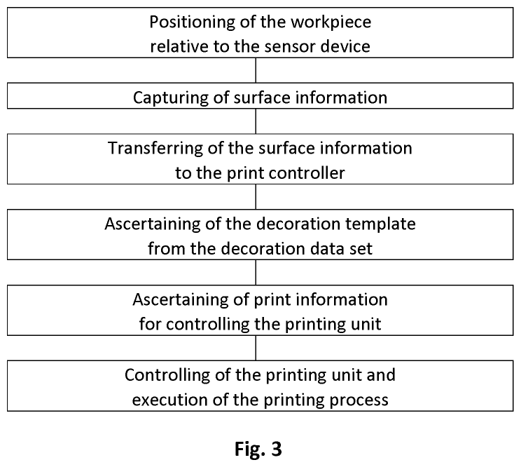

The method for printing on the narrow face 17 is shown in the flow chart in FIG. 3 and is explained below. The method is explained below by reference to printing on one narrow face 17. However, the method is also performed in order to print on the other narrow faces 17 of the workpiece 11 with the narrow face decoration 27. First of all, the workpiece 11 is positioned relative to the sensor device 13. This is carried out in particular by means of the conveyor system 14, which conveys the workpiece 11 in the continuous or discontinuous conveying movement F relative to the printing device 10. During this process, the sensor device 13 captures surface information 23 in a section of the wide face 16. The surface information 23 can be captured in a very small section in relation to the wide face 16, so that the captured surface information 23 generates only a small volume of data. This surface information 23 relates to the workpiece decoration 19 provided on the wide face 16. The surface information 23 is optically captured by means of an image sensor and/or a camera, in particular a multispectral camera. The capture of the surface information 23 can take place during the conveying movement F.

The captured surface information 23 is transferred to a print controller 24. Based on the captured surface information 23, this print controller 24 ascertains print information by means of which the printing unit 12 is controlled in order to carry out the printing process, i.e. to print the narrow face 17 with the narrow face decoration 27. To ascertain the print information, the print controller 24 first uses the captured surface information 23 to ascertain the decoration template 22 that represents the template for the workpiece decoration 19 provided on the workpiece 11. This decoration template 22 is stored in a data store in the print controller 24. Using the surface information 23, the decoration template 22 is ascertained from a plurality of other decoration templates from a decoration data set in the print controller 24. Since the surface information 23 contains only a small volume of data, the data processing times to ascertain the corresponding decoration template 22 can be very short.

The print information for controlling the printing process is ascertained or derived from a defined decoration region 26 of the decoration template 22. To ascertain or derive this decoration region 26, the exact position in the decoration template 22 of the decoration detail 21 provided as the workpiece decoration 18 on the wide face 16 is determined from the captured surface information 23 and the dimensions of the workpiece 11. The decoration region 26 adjoins this decoration detail 21. The decoration region 26 forms a strip-shaped portion adjoining a side edge of the decoration detail 21. The width of the decoration region 26 corresponds to the thickness of the workpiece 11. In this way, the decoration region 26 can be reproduced on the narrow face 17 by means of the printing process. The narrow face decoration 27 is thus a copy of the decoration region 26. The decoration region 26 in the decoration template 22 forms a kind of extension of the decoration detail 21, which is printed on the narrow face 17. A precisely matching decoration flow between the workpiece decoration 19 on the wide face 16 and the narrow face decoration 27 on the narrow face 17 is formed in this way. The decoration flow, shown in FIG. 1 as the woodgrain, thus passes from the wide face 16 to the narrow face 17 in exactly the right position. The workpiece 11 thus appears to have been made from solid wood.

Using the ascertained print information, the print controller 24 then controls the printing unit 12 to carry out the printing process. The position of the printing unit 12 is determined by the positioning device 15 before the start of the printing process, and the printing unit 12 is aligned accordingly with the narrow face 17. The printing unit 12 is positioned using the captured surface information 23 on the basis of the decoration flow of the workpiece decoration 19 on the wide face 19. Once the printing unit 12 has been positioned, the actual printing process begins and the narrow face decoration 27 is printed onto the narrow face 17, in particular onto the coating material on the narrow face 17. To carry out the printing process, the workpiece 11 is moved continuously or discontinuously relative to the printing unit 12 by the conveyor system 14. The capture of the surface information 23 and the execution of the printing process for printing the narrow face decoration 27 can in particular take place in real time, i.e. in direct succession, so that the capture of the surface information and the execution of the printing process are provided substantially at the same time.

Alternatively, the method can also be designed in such a way that, during a traversing movement relative to the workpiece 11, the sensor device 13 captures the surface information 23 in a peripheral region of the wide face 16 adjoining the narrow face 17 to be printed on, and the print information for controlling the printing unit 12 is ascertained by the print controller 24 from the captured surface information 23, in particular in real time. Here, the print information is ascertained or derived from the captured surface information 23 relating to the peripheral region. This print information is used to control the printing unit 12 to carry out the printing process for printing the narrow face decoration 27, wherein the print information is ascertained by the print controller 24 in such a way that the narrow face decoration 27 forms a decoration flow that is matched to the workpiece decoration 19 on the wide face 19. In particular, the capture of the surface information, the ascertaining of the print information and the execution of the printing process are carried out substantially at the same time.

Equally, in an alternative embodiment of the printing method, it can be provided that the surface information 23 is already ascertained at the time of manufacture of the workpiece 11, i.e. following the application of the workpiece decoration 19 on the wide face 19. This surface information 23 is stored in the print controller 24 as workpiece-specific data. If this workpiece 11 is then transported to the printing device 10 in order to print on the narrow faces 17, the workpiece-specific data is retrieved, the corresponding print information is ascertained by the print controller 24, and the printing unit 12 is controlled to carry out the corresponding printing process.

It is clear to the person skilled in the art that individual features described in different embodiments can also be implemented in a single embodiment, provided that they are not structurally incompatible. Equally, different features that are described in the context of a single embodiment can also be provided individually or in any appropriate sub-combination in multiple embodiments.

1-10. (canceled)

11. A method for printing on at least one narrow face of a workpiece, the method comprising:
capturing optically, by a sensor device, surface information relating to at least some regions of at least one workpiece face adjoining the narrow face to be printed on; and
transferring the captured surface information to a print controller, and the print controller ascertains print information for controlling a printing unit based on the captured surface information,
wherein the print information is used to control a printing process by which a narrow face decoration, which is matched to a decoration flow of the optically captured workpiece face, is printed on the narrow face.

12. The method as claimed in claim 11, in which the print controller uses the captured surface information to ascertain a corresponding decoration template from a decoration data set, and the print information for controlling the printing process is ascertained or derived from the decoration template.

13. The method as claimed in claim 12, in which the optically captured workpiece face comprises a workpiece decoration which corresponds to a decoration detail from the ascertained decoration template, wherein the print controller uses the captured surface information and/or the workpiece dimensions to determine the exact position of the corresponding decoration detail from the decoration template, and the print information for printing the narrow face decoration is ascertained from at least one decoration region of the decoration template.

14. The method as claimed in claim 13, in which the print information for printing the narrow face decoration is ascertained from a decoration region of the decoration template that adjoins the decoration detail of the workpiece decoration in the decoration template, wherein the decoration region is printed onto the narrow face in such a way that a matching decoration flow is achieved between the workpiece decoration of the workpiece face and the narrow face decoration of the narrow face.

15. The method as claimed in claim 11, in which moreover the printing unit is positioned relative to the narrow face by a positioning device, wherein the printing unit is arranged in a defined position relative to the narrow face, based on the captured surface information, and the printing process is controlled so as to match the decoration flow of a workpiece decoration of the workpiece face.

16. The method as claimed in claim 11, in which a continuous or discontinuous conveying movement of the workpiece or a continuous or discontinuous traversing movement of the printing unit is performed during the capture of the surface information and/or during the execution of the printing process.

17. The method as claimed in claim 11, in which the surface information relating to a peripheral region of the workpiece face that adjoins the narrow face to be printed on can be optically captured, and the print information for printing the narrow face decoration can be ascertained or derived from the captured surface information relating to the peripheral region.

18. The method as claimed in claim 11, in which the capture of the surface information and the execution of the printing process to print the narrow face decoration are carried out in real time.

19. The method as claimed in claim 18, in which the capture of the surface information and the execution of the printing process to print the narrow face decoration are carried out in direct succession.

20. The method as claimed in claim 11, in which the workpiece is made at least partly of wood, a wood material, synthetic material, or composite material and is provided at least in some regions with a coating material.

21. A printing device for printing on at least one narrow face of a workpiece, comprising:
at least one printing unit configured to print on the at least one narrow face of the workpiece, wherein the printing unit and/or the workpiece are movable relative to one another in order to carry out the printing;
a sensor device configured to optically capture surface information relating to at least some regions of at least one workpiece face adjoining the narrow face to be printed on; and
a print controller configured to carry out the method as claimed in claim 11 to control the at least one printing unit.

22. The printing device as claimed in claim 21, further comprising:
a conveyor system that accommodates a plurality of the workpieces and conveys the workpieces in a continuous or discontinuous conveying movement,
wherein the narrow faces can be printed on by the at least one printing unit during the continuous or discontinuous conveying movement.
